(19) United States
(12) Patent Application Publication
(10) Pub. No.: US 2025/0234404 A1
(43) Pub. Date: Jul. 17, 2025

(54) WIRELESS DEVICE AND METHOD IN A WIRELESS COMMUNICATIONS NETWORK

(71) Applicant: Telefonaktiebolaget LM Ericsson (publ), Stockholm (SE)

(72) Inventors: Patrik RUGELAND, Bromma (SE); Mårten ERICSON, Gammelstad (SE); Gunnar MILDH, Sollentuna (SE); Stefan WAGER, Espoo (FI)

(21) Appl. No.: 18/700,585

(22) PCT Filed: Oct. 12, 2021
(86) PCT No.: PCT/SE2021/050995

§ 371 Date: Apr. 11, 2024

(51) Int. Cl. H04W 76/15; H04L 1/08

(52) U.S. Cl. CPC H04W 76/15; H04L 1/08

(57) ABSTRACT

A method performed by a radio node for handling paths for transmissions related to data packets in a wireless communications network is provided, the radio node is a wireless device or a network node. The wireless device is connected via three or more paths to one or more cell groups. The radio node obtains characteristics of paths associated to the split radio bearer between the wireless device and respective MCG, SCG, and the at least one third cell group. Based on the obtained characteristics of the respective path, the radio node establishes whether to transmit replicas of the data packets, and which one or more paths out of the three or more paths associated to the split radio bearer that shall be used for any one out of transmitting the data packets on or transmitting replicas of the data packets on.

### TECHNICAL FIELD

Embodiments herein relate to a wireless device and methods therein. In some aspects, they relate to determining how to replicate an Uplink (UL) data packet in a wireless communications network.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G, 6G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

In 3GPP TS 36.000 v16.6.0 dual connectivity is defined for intra-Evolved Universal Terrestrial Radio Access (E-UTRA) Dual Connectivity (DC) as depicted in FIG. 1a which highlights the C-plane and in FIG. 1b which highlights U-Plane connectivity. Both Master eNB (MeNB) and Secondary eNB (SeNB) are E-UTRA nodes, with an evolved Packet Core (EPC) CN entity. FIG. 1a depicts C-Plane connectivity of eNBs involved in Dual Connectivity. FIG. 1b depicts U-Plane connectivity of eNBs involved in Dual Connectivity.

In 3GPP 37.340 v 16.7.0, dual connectivity is further defined for Multi-RAT Dual Connectivity (MR-DC), which implies in having a UE configured with two different nodes-one providing E-UTRA access and the other one providing NR access, or two nodes both providing NR access. A CN entity associated to MR-DC can be either EPC or 5GC, which divides MR-DC cases in:
E-UTRA-NR Dual Connectivity (EN-DC), comprised in Evolved Packet System (EPS), as a Master Node (MN) eNB and an en-gNB as a Secondary Node (SN) (en-gNB refers to a gNB that is operating in a non-standalone mode operating as the SN);.
NG-RAN E-UTRA-NR Dual Connectivity (NGEN-DC), comprised in 5G System (5GS), as a MN ng-eNB (ng-eNB refers to LTE eNB connected to 5GC) and an NR gNB as the SN;
NR-E-UTRA Dual Connectivity (NE-DC), comprised in 5GS, as a MN NR gNB and an ng-eNB as the SN;
NR-NR Dual Connectivity (NR-DC), comprised in 5GS, as MN and SN gNBs A gNB or ng-eNB are collectively referred to as NG-RAN node.

C-plane connectivity for EN-DC case is depicted in FIG. 2a, U-Plane connectivity for EN-DC case is depicted in FIG. 2b.

C-Plane connectivity of MR-DC with 5GC is depicted in FIG. 3a, and U-Plane connectivity of MR-DC with 5GC is depicted in FIG. 3b.

Data Radio Bearers (DRBs) may be terminated in either the MN or the SN, i.e., in which logical node a Packet Data Convergence Protocol (PDCP) entity is located. In either case, each bearer may either be transmitted via an MN Radio Link Control (RLC) in a Master Cell Group (MCG) and SN RLC in a Secondary Cell Group (SCG), or via both an MN RLC and an SN RLC using a split bearer as can be seen in FIG. 4.

FIG. 4 depicts network side protocol termination options for MCG, SCG and split bearers in MR-DC with 5GC, e.g., NGEN-DC, NE-DC and NR-DC.

In FIG. 4, SDAP means Data Adaptation Protocol, MAC means Medium Access Control, and QoS means Quality of Service.

### Primary Path and UL Threshold

In dual connectivity, even if a UE is configured with a split bearer, it may not always be beneficial to always split the data between the paths. For instance, if the amount of data is very small, one of the paths can easily accommodate the entire load and by the time the second path has been established, the data transfer has already finished.

To avoid unnecessary establishment of dual connectivity due to small data, an uplink data split threshold (ul-DataSplitThreshold) has been introduced, where if the data is below the threshold, the UE only uses the primary path, whereas if the data exceeds the threshold, it may use whichever path, e.g. utilizing round-robin or any other path-prioritization methods.

Ones the remaining data level drops below the threshold, the UE reverts back to only using the primary path.

From 3GPP TS 38.331 v16.6.0:

| | |
|---|---|
| PDCP-Config ::= | SEQUENCE { |
| drb | SEQUENCE { |
| discardTimer | ENUMERATED {ms10, ms20, ms30, ms40, ms50, ms60, ms75,ms100, |

ms150, ms200,

ms250, ms300, ms500, ms750, ms1500, infinity}

OPTIONAL, -- Cond Setup

| | |
|---|---|
| pdcp-SN-SizeUL | ENUMERATED {len12bits, len18bits} |

OPTIONAL, -- Cond Setup2

| | |
|---|---|
| pdcp-SN-SizeDL | ENUMERATED {len12bits, len18bits} |

OPTIONAL, -- Cond Setup2

| | |
|---|---|
| headerCompression | CHOICE { |
| notUsed | NULL, |
| rchc | SEQUENCE { |
| maxCID | INTEGER (1..16383) |

DEFAULT 15,

| | |
|---|---|
| profiles | SEQUENCE { |
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |

},

| | |
|---|---|
| drb-ContinueROHC | ENUMERATED { true } |

OPTIONAL -- Need N
},

| | |
|---|---|
| uplinkOnlyROHC | SEQUENCE { |
| maxCID | INTEGER (1..16383) |

DEFAULT 15,

| | |
|---|---|
| profiles | SEQUENCE { |
| profile0x006 | BOOLEAN |

},

| | |
|---|---|
| drb-ContinueROHC | ENUMERATED { true } |

```
OPTIONAL -- Need N
      },
      ...
    },
```

| | |
|---|---|
| integrityProtection | ENUMERATED { enabled } |

OPTIONAL, -- Cond ConnectedTo5GC1

| | |
|---|---|
| statusReportRequired | ENUMERATED { true } |

OPTIONAL, -- Cond Rlc-AM-UM

| | |
|---|---|
| outOfOrderDelivery | ENUMERATED { true } |

OPTIONAL -- Need R
}
OPTIONAL, -- Cond DRB

| | |
|---|---|
| moreThanOneRLC | SEQUENCE { |
| primaryPath | SEQUENCE { |
| cellGroup | CellGroupId |

OPTIONAL, -- Need R

| | |
|---|---|
| logicalChannel | LogicalChannelIdentity |

OPTIONAL -- Need R
},

| | |
|---|---|
| ul-DataSplitThreshold | UL-DataSplitThreshold |

OPTIONAL, -- Cond SplitBearer

| | |
|---|---|
| pdcp-Duplication | BOOLEAN |

OPTIONAL -- Need R
}
OPTIONAL, -- Cond MoreThanOneRLC

PDCP-Config field descriptions

ul-DataSplitThreshold
Parameter specified in TS 38.323 [5]. Value b0 corresponds to 0 bytes, value b100
corresponds to 100 bytes, value b200 corresponds to 200 bytes, and so on. The
network sets this field to infinity for UEs not supporting splitDRB-withUL-Both-MCG-
SCG. If the field is absent when the split bearer is configured for the radio bearer first
time, then the default value infinity is applied.

### PDCP Duplication

During 3GPP Release-16, the concept of Ultra-Reliable Low-Latency

Communication (URLLC) was introduced. One aspect which was introduced was packet duplication to introduce redundancy to improve the reliability. To achieve this, the UE is configured with a split bearer where the network or UE transmits the same PDCP Protocol Data Unit (PDU), also referred to as data packet, multiple times, via both the primary and the secondary path.

At the receiver side, the receiving PDCP entity only keeps the PDCP packet copy which was received first and discards any subsequently received packet. This is configured by the network by setting the field pdcp-Duplication in the PDCP-Config 1E for the bearer.

From 3GPP TS 38.331 (v16.4.1)

-- ASN1START
-- TAG-PDCP-CONFIG-START

| | |
|---|---|
| PDCP-Config ::= | SEQUENCE { |
| drb | SEQUENCE { |

<<Omitted parts>>

| | |
|---|---|
| moreThanOneRLC | SEQUENCE { |
| primaryPath | SEQUENCE { |
| cellGroup | CellGroupId |

OPTIONAL, -- Need R

| | |
|---|---|
| logicalChannel | LogicalChannelIdentity |

OPTIONAL -- Need R
},

| | |
|---|---|
| ul-DataSplitThreshold | UL-DataSplitThreshold |

OPTIONAL, -- Cond SplitBearer

| | |
|---|---|
| pdcp-Duplication | BOOLEAN |

OPTIONAL -- Need R
}
OPTIONAL, -- Cond MoreThanOneRLC
<<Omitted parte>>

| | |
|---|---|
| moreThanTwoRLC-DRB-r16 | SEQUENCE { |
| splitSecondaryPath-r16 | LogicalChannelIdentity |

OPTIONAL, -- Cond SplitBearer2

| | |
|---|---|
| duplicationState-r16 | SEQUENCE (SIZE (3)) OF BOOLEAN |

OPTIONAL -- Need S
}
OPTIONAL, -- Cond MoreThanTwoRLC-DRB

| | |
|---|---|
| ethernetHeaderCompression-r16 | SetupRelease { EthernetHeaderCompression-r16 } |

OPTIONAL -- Need M
]]
}
<<Omitted parts>>
-- TAG-PDCP-CONFIG-STOP
-- ASN1STOP

PDCP-Config field descriptions

duplicationState
This field indicates the uplink PDCP duplication state for the associated RLC entities at
the time of receiving this IE. If set to true, the PDCP duplication state is activated for the
associated RLC entity. The index for the indication is determined by ascending order of
logical channel ID of all RLC entities other than the primary RLC entity indicated by
primaryPath in the order of MCG and SCG, as in clause 6.1.3.32 of TS 38.321 [3]. If the
number of associated RLC entities other than the primary RLC entity is two, UE ignores
the value in the largest index of this field. If the field is absent, the PDCP duplication
states are deactivated for all associated RLC entities.
pdcp-Duplication
Indicates whether or not uplink duplication status at the time of receiving this IE is
configured and activated as specified in TS 38.323 [5]. The presence of this field
indicates that duplication is configured. PDCP duplication is not configured for CA
packet duplication of LTE RLC bearer. The value of this field, when the field is present,
indicates the state of the duplication at the time of receiving this IE. If set to true,
duplication is activated. The value of this field is always true, when configured for a
SRB. For PDCP entity with more than two associated RLC entities for UL transmission,
this field is always present. If the field moreThanTwoRLC-DRB is present, the value of
this field is ignored and the state of the duplication is indicated by duplicationState. For
PDCP entity with more than two associated RLC entities, only NR RLC bearer is
supported.

PDCP duplication is possible for both carrier aggregation, where data from a single PDCP entity is duplicated to two radio link control (RLC) entities that are associated to the same Medium Access Control (MAC) entity in the same cell group, and for dual connectivity, where data from a single PDCP entity is duplicated to two radio link control (RLC) entities that are associated to two different MAC entities in separate cell groups. It's also possible to enable duplication for both carrier aggregation and dual connectivity at the same time, enabling up to four duplicates of a packet. FIG. 5a depicts carrier aggregation duplication where the same PDCP PDU is transmitted via two different MCG RLC bearers. FIG. 5b depicts dual connectivity duplication where the same PDCP PDU is transmitted via both an MCG RLC bearer and an SCG RLC bearer. FIG. 5c depicts carrier aggregation and dual connectivity duplication where the same PDCP PDU is transmitted via both two MCG RLC bearers and two SCG RLC bearers.

If a PDCP entity is associated to more than one RLC entity, the network can activate duplication to any one of the RLC entities. The UE will then transmit the data via the primary path and duplicate it via any of the RLC bearers which have duplication activated.

From 3GPP TS 38.323 (V16.5.0)

5.2 Data transfer
5.2.1 Transmit operation
At reception of a PDCP SDU from upper layers, the transmitting PDCP entity shall:

| | |
|---|---|
| - | start the discardTimer associated with this PDCP SDU (if configured). |

For a PDCP SDU received from upper layers, the transmitting PDCP entity shall:

| | |
|---|---|
| - | associate the COUNT value corresponding to TX_NEXT to this PDCP SDU; |

| | |
|---|---|
| NOTE 1: | Associating more than half of the PDCP SN space of contiguous PDCP SDUs |
| | with PDCP SNs, when e.g., the PDCP SDUs are discarded or transmitted |
| | without acknowledgement, may cause HFN desynchronization problem. How |
| | to prevent HFN desynchronization problem is left up to UE implementation. |

| | |
|---|---|
| - | perform header compression of the PDCP SDU using ROHC as specified in the |
| | clause 5.7.4 and/or using EHC as specified in the clause 5.12.4; |
| - | perform integrity protection, and ciphering using the TX_NEXT as specified in the |
| | clause 5.9 and 5.8, respectively; |
| - | set the PDCP SN of the PDCP Data PDU to TX_NEXT modulo 2^{[pdcp-SN-Size UL]}; |
| - | increment TX_NEXT by one; |
| - | submit the resulting PDCP Data PDU to lower layer as specified below. |

When submitting a PDCP PDU to lower layer, the transmitting PDCP entity shall:

| - | if the transmitting PDCP entity is associated with one RLC entity: | |
|---|---|---|
| | - | submit the PDCP PDU to the associated RLC entity; |
| - | else, if the transmitting PDCP entity is associated with at least two RLC entities: | |
| | - | if the PDCP duplication is activated for the RB: |

| | |
|---|---|
| - | if the PDCP PDU is a PDCP Data PDU: |

- duplicate the PDCP Data PDU and submit the PDCP Data PDU to the
associated RLC entities activated for PDCP duplication;

| | |
|---|---|
| - | else: |

- submit the PDCP Control PDU to the primary RLC entity;
<...>

| | |
|---|---|
| - | else: |

- submit the PDCP PDU to the primary RLC entity.

WO2019137721 describes a method for transmitting PDCP PDU, that uses carrier aggregation or dual connectivity to send PDU to destination on a first path using a first carrier.

US2020236734 teaches a method for PDCP PDU duplication for a UE involving receiving a MAC Control element comprising fields for switching active RLC entities. EP3641192 depicts a method for processing communication in a computing device e.g., a mobile phone. The method involves receiving indication information by radio access network, and determining whether a repeating pattern is activated by field.

### Triple/Multi Connectivity

In 3GPP NR Release 15, two separate frequency ranges were introduced: FR1: <7.125 GHz and FR2: 24.250-52.65 GHz.

In 3GPP TR 38.380 (v16.0.0) it is discussed the potential to introduce a new frequency range between 7-24 GHZ, preliminary known as FR3. In addition, it is considered for 6G to introduce sub-THZ (<300 GHZ), THz (300 GHz-2 GHZ) as well as visual light communication (400-800 THz) and optical wireless communication (OWC) (100 THz-1000 THz). Even though the entire ranges will not be address simultaneously, even if only one of them is used, it is likely this would have to be handled by a separate physical layer compared to FR1 or FR2. Thus it is likely that some devices may implement simultaneous connectivity to at least three different frequency ranges at once, i.e. using triple or multi-connectivity i.e., more than tree paths.

### SUMMARY

As part of developing embodiments herein the inventors have identified a problem which first will be discussed.

If PDCP duplication is activated, the UE transmits the same packet to all available paths. If the UE is configured with three or more paths, enabling duplication will send three (or more) copies of every packet, out of which only one may be kept. In case reliability is most important, this may be a valid approach. However, if a UE is configured with multiple paths, not all of them may be as reliable and of similar bandwidths. Thus, duplicating the data packets to all paths would result in increased overhead without any increased reliability.

An object of embodiments herein is to improve the performance of a wireless communications network using triple or multi-connectivity.

According to an aspect of embodiments herein, the object is achieved by a method performed by a radio node for handling paths for transmissions related to data packets in a wireless communications network. The radio node is any one out of a wireless device or a network node. The wireless device is via three or more paths to one or more cell groups. The wireless device is configured with a split radio bearer comprising the three or more paths between the wireless device and the one or more cell groups. The radio node obtains characteristics of paths associated to the respective path out of the three or more paths. Based on the obtained characteristics of the respective path, the radio node establishes whether or not to transmit replicas of the data packets, and which one or more paths out of the three or more paths associated to the split radio bearer that shall be used for any one out of: Transmitting the data packets on or transmitting replicas of the data packets on.

According to another aspect of embodiments herein, the object is achieved by a radio node configured to handling paths for transmissions related to data packets in a wireless communications network. The radio node is adapted to be any one out of: A wireless device and a network node 110. The wireless device is connectable via three or more paths to one or more cell groups. The wireless device is adapted to be configured with a split radio bearer comprising the three or more paths between the wireless device and the one or more cell groups. The radio node is further being configured to:

Obtain characteristics of the respective path out of the three or more paths,
based on the obtained characteristics of the respective path, establish whether or not to transmit replicas of the data packets, and which one or more paths out of the three or more paths associated to the split radio bearer that shall be used for any one out of: Transmitting the data packets on, or transmitting replicas of the data packets on.

Thanks to that the radio device obtains characteristics of paths associated to the split radio bearer comprising the three or more paths between the wireless device and the one or more cell groups, the radio node is enabled to establish whether or not to transmit replicas of the data packets, and which one or more paths out of the three or more paths associated to the split radio bearer that shall be used for transmitting the data packets on or transmitting replicas of the data packets on. In this way, an efficient way to make it clear between which paths the data packets shall be replicated is achieved which thus improves the performance of the wireless communications network using multi-connectivity.

### BRIEF DESCRIPTION OF THE DRAWINGS

Examples of embodiments herein are described in more detail with reference to attached drawings in which:

FIG. 1a is a schematic block diagram illustrating prior art.

FIG. 1b is a schematic block diagram illustrating prior art.

FIG. 2a is a schematic block diagram illustrating prior art.

FIG. 2b is a schematic block diagram illustrating prior art.

FIG. 3a is a schematic block diagram illustrating prior art.

FIG. 3b is a schematic block diagram illustrating prior art.

FIG. 4 is a schematic block diagram illustrating prior art.

FIG. 5 is a schematic block diagram illustrating prior art.

FIG. 6 is a schematic block diagram illustrating embodiments of a wireless communications network.

FIG. 7 is a schematic block diagram illustrating an example of embodiments herein.

FIG. 8 is a flowchart depicting an embodiment of a method in a wireless device.

FIG. 9 is a schematic block diagram illustrating an example of embodiments herein.

FIG. 10 is a schematic block diagram illustrating an example of embodiments herein.

FIG. 11 is a chart diagram illustrating an example of embodiments herein.

FIG. 12 is a flowchart illustrating an example method of embodiments herein.

FIGS. 13a-b are schematic block diagrams illustrating embodiments of a wireless device.

FIG. 14 schematically illustrates a telecommunication network connected via an intermediate network to a host computer.

FIG. 15 is a generalized block diagram of a host computer communicating via a base station with a user equipment over a partially wireless connection.

FIGS. 16-19 are flowcharts illustrating methods implemented in a communication system including a host computer, a base station and a user equipment.

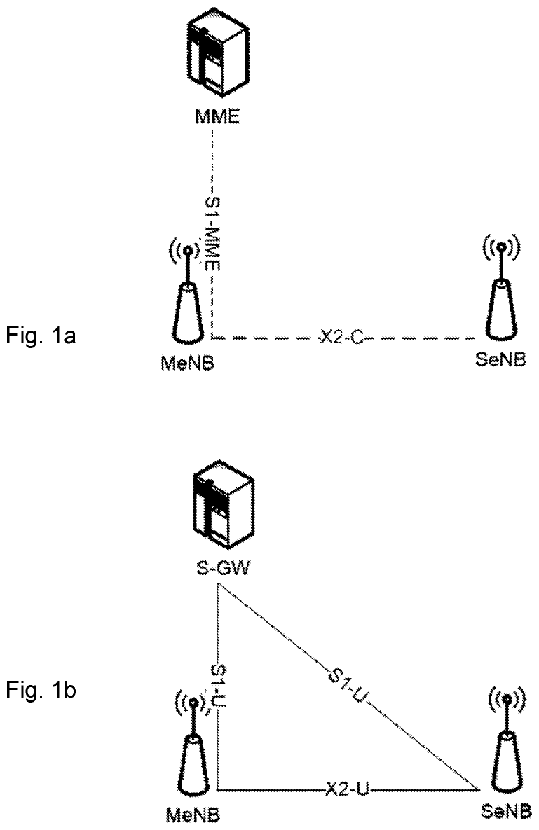

### DETAILED DESCRIPTION

Some example embodiments herein are related to 6G, triple connectivity, dual connectivity, and PDCP duplication.

Embodiments herein provide an efficient way to make it clear between which paths a wireless device shall duplicate the traffic when the wireless device is configured with three or more paths.

In some example embodiments herein, the wireless device is configured with a three-way split bearer and packet duplication is activated. Instead of duplicating the packets on all three paths, the wireless device may determine whether or not a data packet should be replicated and determines a selection of paths to use for the data packed or the replicas of the data packet according to the decisions.

It should be noted that the terms duplicate, and replicate may be used interchangeably herein and refers to when a wireless device transmits the same PDCP PDU multiple times via different RLC entities.

In some embodiments, when determined that a data packet should not be replicated the wireless device selects to use a first path for sending non-replicated data packets, meaning that in this case a second or third paths are not used. As an alternative the wireless device determines that a data packet should be replicated and selects a second and third path to be used for sending the replicated data packets, meaning that in this case the first path is not used.

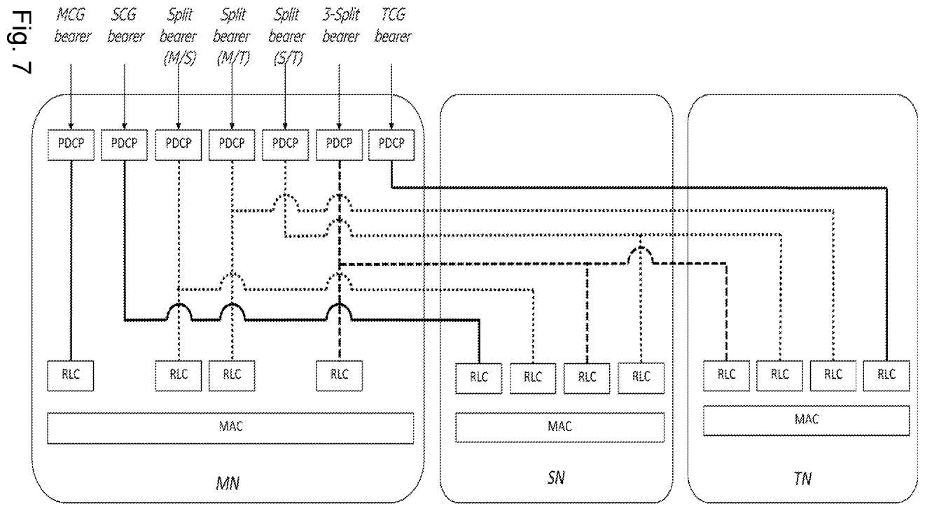

FIG. 6 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, 6G, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a network node 110, a second network node 112, and a third network node 113. The network nodes 110 provide radio coverage in one or more cells or cell groups.

The network nodes e.g., including the network nodes 110, 112, and 113 provide cell groups such as e.g., any of an MCG 115 e.g., if being an MN, an SCG 116 e.g., if being an SN, and at least one third cell group 117 e.g., if being a Tertiary Node (TN).

The network nodes 110, 111 and 112 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with wireless devices, such as e.g. a wireless device 120, within the cell group served by the respective network nodes depending e.g. on the first radio access technology and terminology used. The network node 110 may communicate with wireless devices, such as e.g., a wireless device 120, in DL transmissions to the wireless devices, and UL transmissions from the wireless devices.

A number of wireless devices operate in the wireless communication network 100, such as e.g., the wireless device 120. The wireless device 120 may also be referred to as a UE, a device, an IoT device, a mobile station, a non-access point (non-AP) STA, a STA, a user equipment and/or a wireless terminal, communicate via one or more Access Networks (AN), e.g., RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating within a cell.

The wireless device 120 is configured with a split radio bearer comprising the three or more paths between the wireless device 120 and the one or more cell groups, e.g., between the wireless device 120 and the MCG, SCG, and at least a third cell group in at least three paths. The three paths comprise at least a first path 131, a second path 132 and a third path 133.

Methods herein may be performed by a radio node such as anyone out of the wireless device 120 or the network node 110, the radio node performing the method is therefore referred to as the radio node 110, 120.

As an alternative, a Distributed Node (DN) and functionality, e.g., comprised in a cloud 135 as shown in FIG. 6, may be used for performing or partly performing the methods herein.

FIG. 7 depicts bearer configuration options in triple connectivity for MN terminated bearers. Similar options for SN and TN terminated are possible. Solid lines: single cell group, dotted lines: two cell groups, dashed lines: three cell groups.

According to an example, the wireless device 120 is connected to 3 cell groups, also referred to as triple connectivity, with a three-way split bearer across all three cell groups, to enable duplication of uplink data between only two of the paths and use the third path as an alternative path for data aggregation. Embodiments herein provides a way of selecting which of the at least three paths the wireless device 120 shall use for a data packet and how to signal the configurations to the wireless device 120.

According to another example, the wireless device 120 is connected to two cell groups and is configured with a split radio bearer across two cells in one of the cell groups and across a third cell in the other cell group enabling duplication of data between two of the paths and use the third path as an alternative path for data aggregation.

Advantages of embodiments herein e.g., comprise: a better flexibility, they will both increase the throughout and increase the reliability. By enabling partial replication, the wireless communications network 100 such as the network node 110 increases the reliability of only one of the paths. For instance, if a first path has great coverage, whereas the second and third path have complementary spotty coverage, if the wireless device 120 then replicates data packets sent via the second and third paths, this would enhance the reliability, whereas non-replicated data packets transmitted via the first path will be received with high reliability already. It is also possible for the network to configure the wireless device 120 with critical services requiring exceptional service availability to use all the available at least three paths (3+) to transmit the same data packet such as e.g. PDCP PDU.

### Transmitting Data Packets And” Transmitting Replicas of Data Packets

When using the terminology of “transmitting data packets” and” “transmitting replicas of data packets” the transmitting data packets means that the data packets are not replicated.

The transmitting of the replica of the data packet means that the data packet is replicated.

In some embodiments, there is no “original data packet and its replica” but two or more identical data packets are transmitted, referred to as replicas of the data packet.

In some other embodiments, there is one “original data packet” and one or more “replicas of the original data packet”, i.e., one “original data packet” and one or more “copies of the original data packet”. The “original data packet” and the one or more “replicas of the original data packet” are also referred to as “replicas of the data packet”. In TS 38.300 (v1.6.0), this is described as: “Duplication at PDCP therefore consists in submitting the same PDCP PDUs multiple times: once to each activated RLC entity for the radio bearer.”

A number of embodiments will now be described in a general way, some of which may be seen as alternatives, while some may be used in combination. This will be followed by a more detailed description and examples.

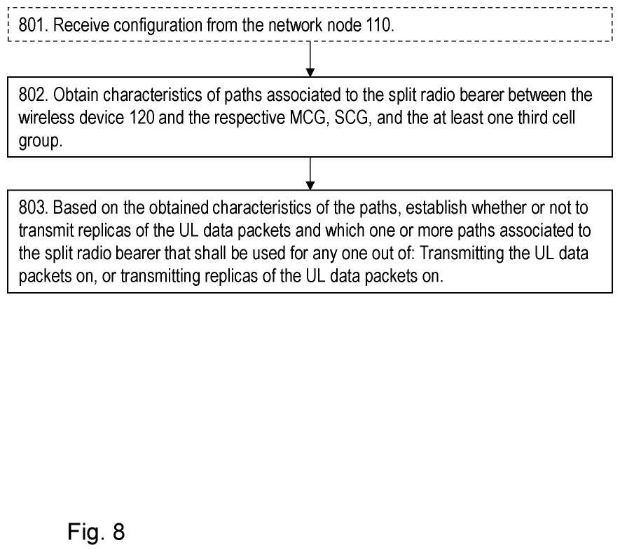

FIG. 8 shows example embodiments of a method performed by the radio node 110, 120 for handling paths for transmissions related to data packets in the wireless communications network 100. The data packets may be uplink or downlink data packets. The radio node 110, 120 may be any one out of the wireless device 120 and the network node 110. The wireless device 120 is connected via three or more paths to one or more cell groups. In some embodiments, the wireless device 120 is connected to multiple third cell groups. Thus, the wireless device 120 being connected to the third cell group may comprise that the wireless device 120 is connected to multiple third cell groups. The multiple third cell groups may be identified as multiple tertiary paths.

The wireless device 120 is configured with a split radio bearer comprising the three or more paths between the wireless device 120 and the one or more cell groups, e.g. a split radio bearer to the MCG, SCG, and the third cell group.

The one or more cell groups comprises a Master Cell Group, MCG, a Secondary Cell Group, SCG, and one or more third cell group, and/or the third cell group is adapted to comprise any one out of an SCG2, a Tertiary Cell Group (TCG).

The method comprises the following actions, which actions may be taken in any suitable order. Optional actions are referred to as dashed boxes in FIG. 7.

### Action 801

In some embodiments, wherein the radio node 110, 120 is a wireless device 120, the wireless device 120 receives a configuration from the network node 110. The configuration configures the wireless device 120 to perform the establishing in Action 803.

In some embodiments, the configuration further comprises any one or more out of:
Which of the paths to any of the respective one or more cell groups such as e.g. to the respective MCG, SCG, and the third cell group, that are associated to the split radio bearer. The paths may comprise at least the first path 131, the second path 132 and the third path 133. And:
Which of the respective paths 131, 132, 133 that are identified as a primary path, a secondary path B, and a tertiary path C.

The following should be noted:

The first path 131 may e.g., be any of the primary path A, a secondary path B, and a tertiary path C. Also the second path 132 may e.g. be any of the primary path A, a secondary path B, and a tertiary path C. Further, the third path 133 may e.g., be any of the primary path A, a secondary path B, and a tertiary path C. However, the three paths 131, 132, 133 are different meaning that the respective path 131, 132, 133 may be associated to one path each out of the primary path A, a secondary path B, and a tertiary path C.

In some embodiments, the configuration further comprises the below obtaining 802 of said characteristics of paths. Meaning that the characteristics of the paths may be obtained by being comprised in the configuration.

### Action 802

The radio node 110, 120 obtains characteristics of the respective path out of the three or more paths. The characteristics of the paths will be used as a basis to establish, e.g., decide, whether to replicate the data packets in a n action below. The characteristics of the paths may e.g. relate to a quality of the respective path such as e.g., Reference Signal Received Power (RSRP), Reference Signal Received Quality (RSRQ), Signal-to-Interference-plus-Noise Ratio (SINR). Further, the characteristics of the paths may be e.g., a rule measurement such as relative signal quality between different connected paths. E.g. the signal quality of the first path is a threshold value better than secondary path. Further, the characteristics of the paths may be e.g., a carrier frequency or bandwidth associated with the path.

In some embodiments, the radio node 110, 120 obtains the characteristics of paths related to the split radio bearer by measuring the signal quality of the paths, comprising at least a first path 131, a second path 132 and a third path 133, to the respective MCG; SCG, and the third cell group.

### Action 803

Based on the obtained characteristics of the respective path, the radio node 110, 120 establishes whether or not to transmit replicas of the data packets. The wireless device 120 further establishes which one or more paths out of the three or more paths associated to the split radio bearer, that shall be used for any one out of: Transmitting the data packets on or transmitting replicas of the data packets on.

It should be noted that, as used herein, the wording to “establish” which one or more paths that shall be used may also be referred to as to “select or decide” which one or more paths that shall be used.

In some embodiments, wherein the radio node 110, 120 has obtained the characteristics of paths related to the split radio bearer by measuring the signal quality of the paths, the radio node 110, 120 performs said establishing based on the obtained characteristics of the respective path, by determining whether or not to transmit replicas of the data packets, and which one or more paths that shall be used for transmitting the data packets on, or transmitting replicas of the data packets on, based on whether the measured signal quality of the respective path is fulfilling a criterion associated to each of the respective path.

In some embodiments, the radio node 110, 120 establishes whether or not to transmit replicas of the data packets, and which one or more paths that shall be used for transmitting the data packets on, or transmitting replicas of the data packets on, based on the obtained characteristics of the respective path, by further basing it on an amount of data in a data buffer of the radio node 110, 120.

In some embodiments, the paths comprise at least a first path 131, a second path 132 and a third path 133, and the wireless device 120 performs said establishing by determining whether:
A first path 131 shall be used for transmitting the data packets on, and neither of a second path 132 and a third path 133 shall be used for transmitting replicas of the data packets on, or
the second path 132 and the third path 133 shall be used for transmitting replicas of the data packets on, and the first path 133 shall not be used for transmitting the data packets on.

In some alternative embodiments, the paths comprise at least a first path 131, a second path 132 and a third path 133, and the radio node 110, 120 performs said establishing, by determining to send replicas of the data packets and that the first path 131 shall be used for transmitting one replica of data packets on and determining that any one out of:
the second path 132 shall be used for transmitting another replica of the data packets on, or
the third path 133 shall be used for transmitting another replica of the data packets on.

In some embodiments there are four paths, in that case there may be a grouping of the paths, so that the choices are:
(Path A+path B) or (path C+path D); or
Path A or (path B+path C+path D); or
Path A or path B or (path C+path D).

The above embodiments will now be further explained and exemplified below. The embodiments below may be combined with any suitable embodiment above.

Some embodiments described herein are described for uplink split bearer, where the new replication behavior may be specified in standardization. However, the same solutions would apply for downlink, where the network itself may determine which paths should be used. Therefore the embodiments of the method may be performed by any of the wireless device or the network node 110.

It should be noted that in the below text, examples of the method are described by being performed by the wireless device 120 applied on uplink. However these examples of the method may as well be performed by the network node 110 and be applied for downlink.

### Partial Duplication

The wireless device 120 is configured with 3 or more paths, embodiments herein make it clear between which paths the wireless device 120 shall duplicate the traffic.

In some embodiments, e.g., if a field inside the information element, IE, pdcp-Config in the configuration is configured, set to TRUE, the wireless device 120 establishes that replicas of the data packets shall transmitted on all between all configured paths, e.g., first, second and at least one third path, such as primary path, secondary path, tertiary path, etc.

In some other embodiments, a new field may be introduced in the configuration which indicates which paths should be used for replication of the data packets, i.e., if a new field, e.g., paths ToDuplicate in the IE pdcp-Config is configured (e.g., set to TRUE or configured to a specific value). If the pathsToDuplicate is absent, the wireless device 120 establishes to transmit replicas of the data packets over all available paths.

The paths ToDuplicate field in the configuration may contain the following:

| | |
|---|---|
| pathsToDuplicate | CHOICE { |
| primaryAndSecondary | BOOLEAN, |
| primaryAndTertiary | BOOLEAN, |
| secondaryAndTertiary | BOOLEAN, |
| duplicateToPrimary | BOOLEAN, |
| duplicateToSecondary | BOOLEAN, |
| duplicateToTertiary | BOOLEAN, |

spare2, spare1|
} OPTIONAL -- Need R

It should be understood by the skilled in the art that the name of the field “pathsToDuplicate” and the content is an example and can be replaced by another name and may be structured in a different way, providing the same, similar, a subset, or additional configurations.

A DRB is split between the first, second and third paths such as e.g. between the primary, secondary and tertiary path, but depending on the choice, e.g. the established whether or not to transmit replicas of the data packets, and which one or more paths out of the three or more paths associated to the split radio bearer that shall be used, the data packets will be split or duplicated via different paths.

In some embodiments where there are three paths 131, 132, 133, and the wireless device 120 should replicate data between two of the paths, there are two alternatives, and multitude of permutations, to use:

In the below examples, the primary path A is referred to as path A, the secondary path B is referred to as path B, and a tertiary path C is referred to as path C.

As hinted above the respective path A, B and C may be associated to one path each out of the first path 131, the second path 132, and the third path. 133

In the first alternative, the wireless device 120 establishes such as determines which one of two paths, such as selects between two of the paths, to transmit on;
a. if one of them is selected, e.g., path A, duplicate to the second path B.
b. If the path C is selected, don't replicate.

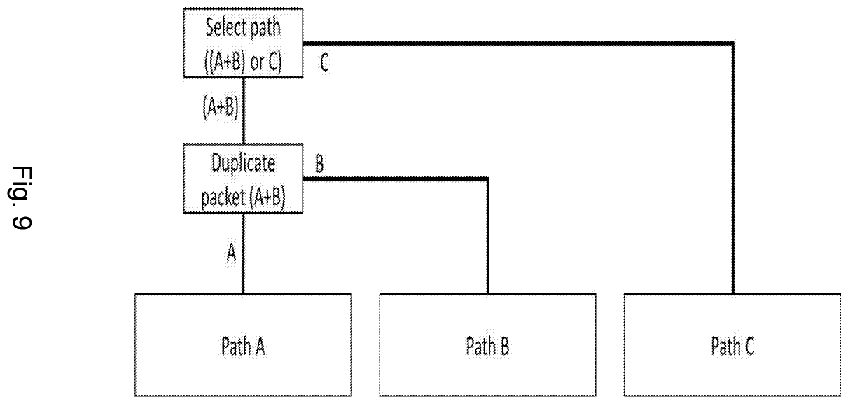

An example of this is depicted in FIG. 9 illustrating the establishing, when comprising selecting data packet replication transmission on two paths A+B, or select data packet (no replication) transmission on one path C.

In the second alternative, the wireless device 120 establishes such as determines to replicate the data packets and send one of the copies on one path, e.g., predefined in the configuration, for the other copy the wireless device 120 establishes such as determines to select which of the remaining paths to transmit on.

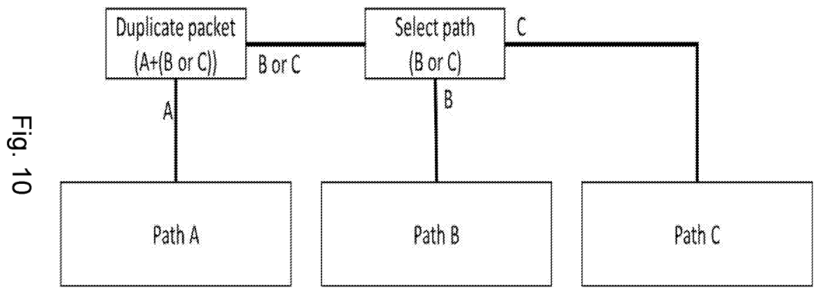

An example of this is depicted in FIG. 10 illustrating the establishing, when comprising: always replicate the data packets and send one of the copies on one path A, e.g., predefined in the configuration, for the other copy the wireless device 120 establishes such as determines to select which of path B or path C to transmit on.

The selection of path and replication may be done in any order, i.e., first select between two paths to transmit one of the replicas of the data packets on, and regardless of which path is selected, the other replica of the data packets will be transmitted on the third path.

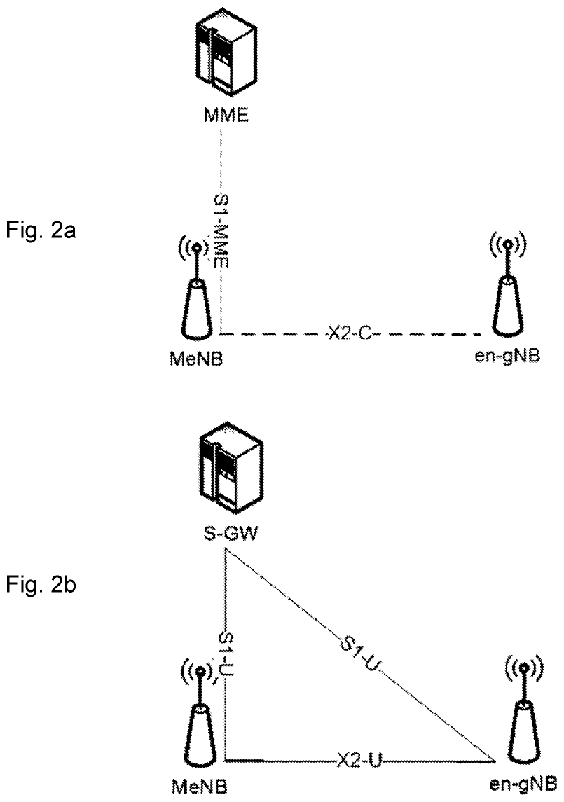

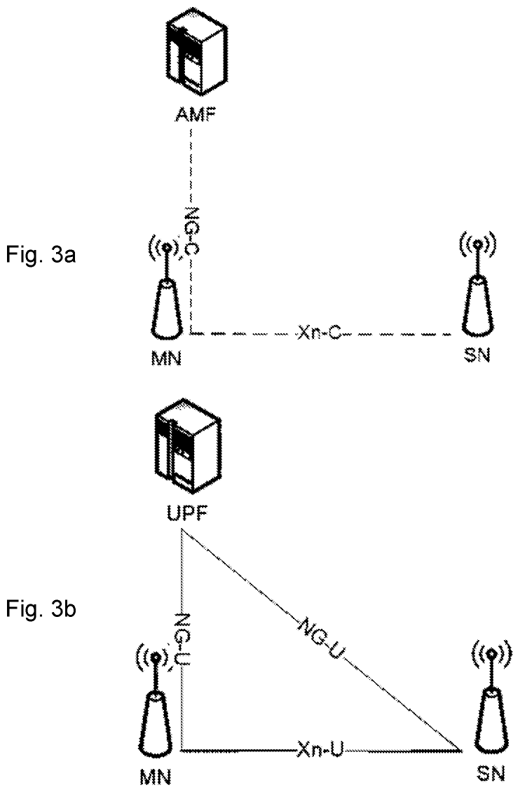

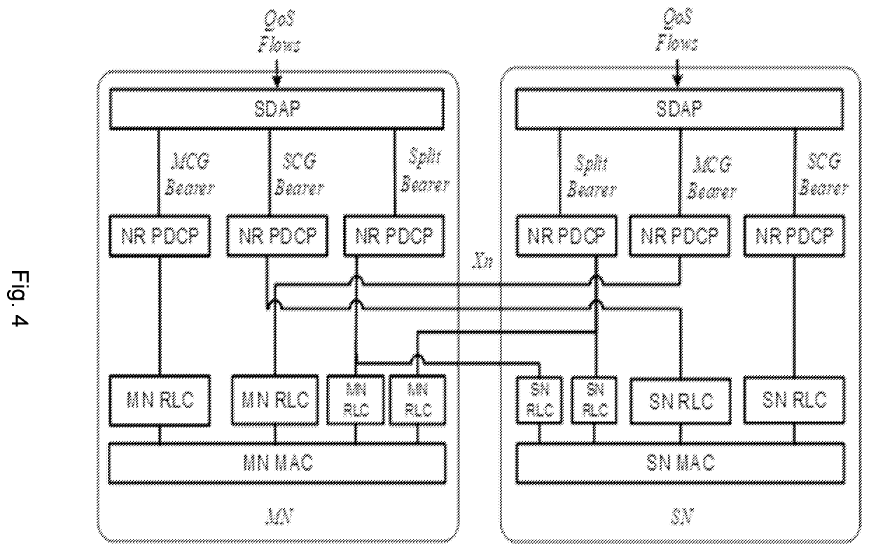

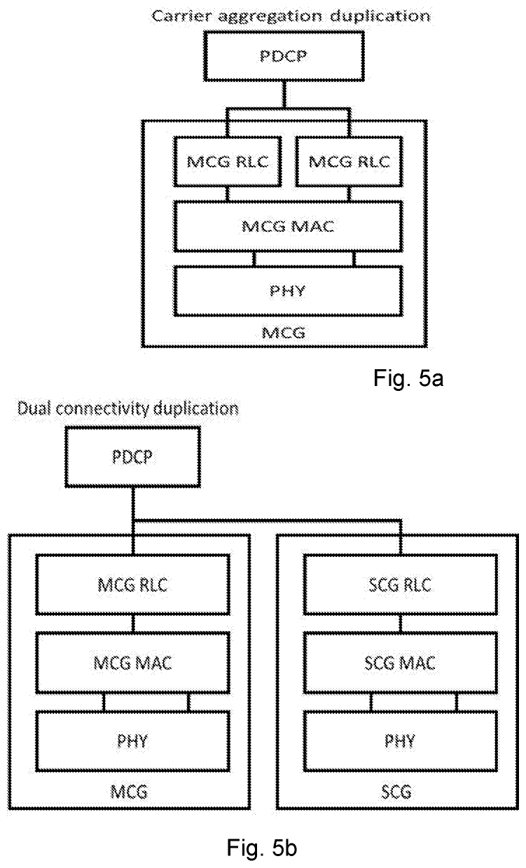

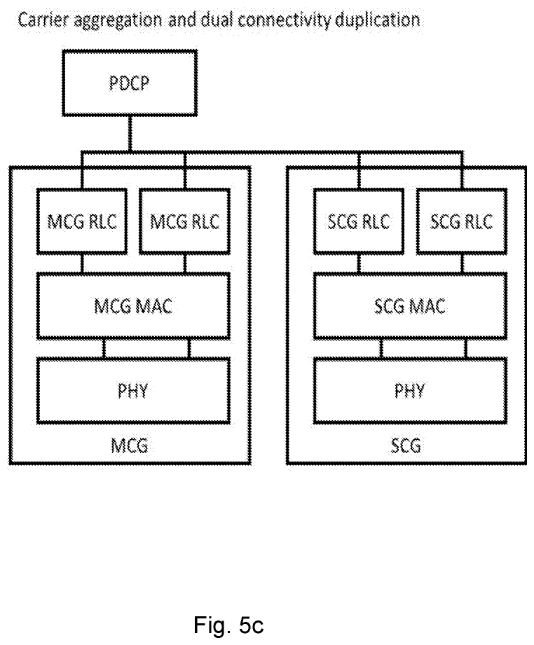

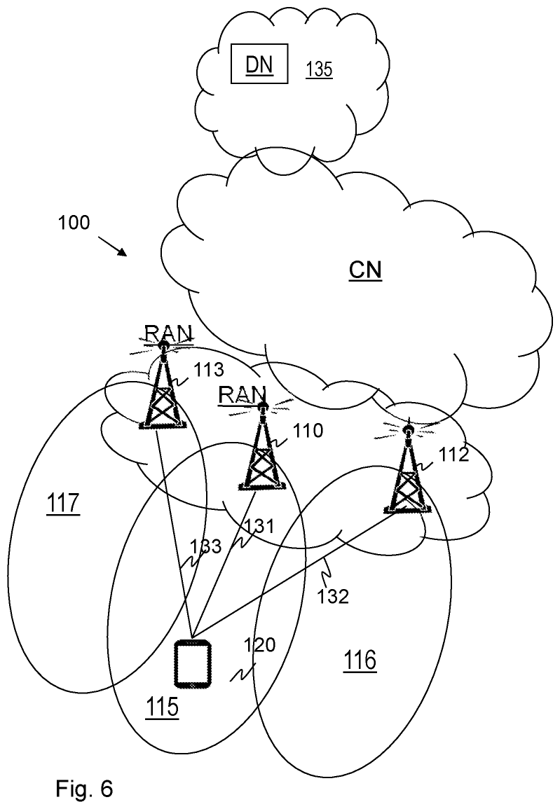

Any permutation of the first, second or third paths such as e.g., the primary, secondary, and tertiary path, is possible. This means that either path A, B, or C in FIG. 2 and FIG. 3 may be the first, second or third paths such as e.g., the primary, secondary or tertiary path.

Different combinations of selecting between the three paths and replicating packets between two of them may be envisioned as follows:
1. (Path A AND Path C) OR Path B,
2. (Path A AND Path B) OR Path C,
3. Path A AND (Path B OR Path C),
4. Path A OR (Path B AND Path C),
5. (Path A OR Path B) AND Path C,
6. (Path A OR Path C) AND Path B.

In some embodiments, the wireless device 120 is additionally configured with one or more thresholds relating to the amount of data packets in the buffer of the wireless device 120, used to determine whether to select which paths to transmit data on, and when to use a fixed selection of paths, e.g. only the primary path A. In some embodiments, a single threshold is used, e.g., a threshold may be referred to as UL Split Data Threshold (ul-SplitDataThreshold). This means that the wireless device 120 may use e.g., the primary path if the data buffer is below the threshold only one particular path is used e.g., the primary path A or the data is duplicated on two specific paths, e.g. the primary path A and the secondary path B. If the data is above the threshold, the wireless device 120 may select between the transmission alternatives it has been configured with.

In some embodiments, the wireless device is configured with two separate thresholds, e.g., the second threshold referred to as ul-SplitDataThreshold2. ul-SplitDataThreshold and ul-SplitDataThreshold2 are two different thresholds. This means that if the data buffer is below both of the thresholds, the wireless device 120 does not select between different paths, nor duplicates the data packets between the paths. If the data buffer is larger than one of the thresholds and smaller than the other threshold, the wireless device 120 performs one out of:
Select to transmit the data packets through a subset of the paths, e.g., via either the primary path A or the secondary path B; or
Duplicate the data via a subset of the paths, e.g. duplicate the data via primary path A and secondary path B.

If the data buffer is above both thresholds, the wireless device considers all three paths for transmission, either for selection of path or for duplication of transmission.

In the below examples the term duplicate is representing the term replicate as used above.

Primary path A and Secondary path B: If the data buffer is below the ul-SplitDataThreshold2, the wireless device 120 selects to duplicate data between the primary path A and the secondary path B. If the data buffer is above the ul-SplitDataThreshold2, the wireless device 120 selects either primary path A or tertiary path

C to transmit the data packets on. If the wireless device 120 selects the primary path A, the data packets are duplicated between the primary path A and the secondary path B. If the wireless device 120 selects the tertiary path C, the data packets are not duplicated and are transmitted only via the tertiary path C.

Primary path A and Tertiary path C: If the data buffer is below the ul-SplitDataThreshold, the wireless device 120 duplicates data between the primary path A and tertiary path C. If the data buffer is above ul-SplitDataThreshold, the wireless device 120 selects either the primary path A or the secondary path B to transmit the data packets on. If the wireless device 120 selects the primary path A, the data packets are duplicated between the primary path A and the tertiary path C. If the wireless device 120 selects the secondary path B, the data packets are transmitted only via the secondary path B.

Secondary path B and Tertiary path C: If the data buffer is below the ul-SplitDataThreshold, the wireless device 120 transmits the data packets only via the primary path A. If the data buffer is above ul-SplitDataThreshold, the wireless device 120 selects either the primary path A or the secondary path B to transmit the data packets on. If the wireless device 120 selects the primary path A, the data packets are transmitted only via the primary path A. If the wireless device 120 selects the secondary path B, the data packets are duplicated between the secondary path B and tertiary path C.

Duplicate to primary path A: If the data buffer is below the ul-SplitDataThreshold and ul-SplitDataThreshold2, the wireless device 120 establishes to transmit the data packets only via the primary path A. If the data buffer is above the ul-SplitDataThreshold but below the ul-SplitDataThreshold2, (and vice versa if threshold is larger than threshold2), the wireless device 120 establishes to duplicate the data between the primary path and the secondary path. If the data buffer is larger that both ul-SplitDataThreshold and ul-SplitDataThreshold2, the wireless device 120 selects either the secondary path or the tertiary path to transmit on and then duplicates the data to the primary path. This is a case which uses two thresholds. The others may use only one of them. Duplicate to secondary path B: If the data buffer is below the ul-SplitDataThreshold, the wireless device 120 establishes to duplicate data between the primary path A and the secondary path B. If the data buffer is larger than ul-SplitDataThreshold, the wireless device 120 selects either the primary path A or the tertiary path C to transmit the data packets on and then duplicates the data packets to the secondary path B. This means that the data packets are duplicated between the primary path A or secondary path B, and the tertiary path C.

Duplicate to tertiary path C: If the data buffer is below ul-SplitDataThreshold, the wireless device 120 establishes to duplicate the data packets between the primary path A and the tertiary path C. If the data buffer is larger than ul-SplitDataThreshold2, the wireless device 120 selects either the primary path A or the secondary path B to transmit one of the duplicate the data on and to transmit the other of the duplicate the data on the tertiary path C.

The following is examples of the establishing 803 performed by the wireless device 120.

For the case where the data is transmitted via either one link or duplicated via the other two (e.g., the primary path A and the secondary path B), the scenario may be that the reliability of the tertiary path C is much higher than the reliability of the two other paths. Thus, in order to enhance the reliability of the first two paths, the data packets may be duplicated, whereas if the third path is very reliable and may be used to boost throughput.

For the case where the data packets are either transmitted via one or another path, but is always duplicated to a third path (e.g., Duplicate to the tertiary path C), the scenario may be that the throughput of the third path is much higher than the first or second, but the reliability is much lower. While the third path successfully transmits the data packets, the data packets transmitted via the third path are received faster than through the first or second path. However, once the third path loses the connectivity, the duplicated data packets sent via the first or second path continue.

In case of multi path, i.e., more than three paths, connectivity, the duplication of the data packets may comprise more than two replicas, e.g.:
The wireless device 120 selects either the primary path A or the secondary path B. If the wireless device 120 selects the primary path A, it duplicates data packets between the primary path A and the tertiary path C. If it selects the secondary path B it duplicates the data packets between the secondary path B and a quaternary path D.
The wireless device 120 selects either the primary path A or the secondary path B. If the wireless device 120 selects primary path A, it duplicates the data between the primary path A, the tertiary path C and the quaternary path D. If the wireless device 120 selects the secondary path B, it only transmits the data packets on the secondary path B.
All other combinations of duplicating one or more paths to one or more other paths.

### Triggers to Establish Activation of Duplication

In some embodiments, the wireless device 120 establishes 803 to only activate duplication if one or more of the considered paths are below a certain signal threshold. The thresholds may e.g., be related to the characteristics of paths associated to the split radio bearer as mentioned above, such as e.g., RSRP, RSRQ, and SINR.

If the signal quality relating to a signal of a path drops significantly low when the wireless device 120 measures it, e.g., in obtaining characteristics of paths associated to the split radio bearer, the wireless device 120 may report the measurements to the network such as e.g. the network node 110. The network such as e.g., the network node 110 may then either release the entire cell group, perform a handover or reconfigure the wireless device 120 to access a different cell. Thus, the duplication signal threshold for duplicate the data packets may need to be above the measurement event threshold.

In some other embodiments herein, the wireless device 120 is configured with triple connectivity and a three-way split bearer, e.g., three paths. In some other embodiments herein the wireless device 120 is configured with more than three connections and a bearer split in more than three ways, e.g., more than three paths. The wireless device 120 may then receive one or more signal thresholds when to enable replication such as e.g., referred to as duplication. This may e.g., be included in the characteristics of paths associated to the split radio bearer, or the received configuration. This may be done in combination with the embodiments listed for partial duplication, i.e., the wireless device 120 is explicitly informed of a subset of the paths the wireless device 120 should use for duplication, e.g., duplicate on path A and B, or use path C. If the paths indicated for duplication are below the one or more signal thresholds, the wireless device 120 establishes 803 to use them for duplication, otherwise if both paths are above the one or more signal thresholds, the wireless device 120 establishes 803 to use the paths for replication of more than two copies of the data packets, also referred to as aggregation.

In some other embodiments, the wireless device 120 only receives the one or more signal thresholds for duplication as characteristics of paths associated to the split radio bearer. If the signal for a path goes below the associated duplication signal threshold, the wireless device 120 begins to use that path to duplicate UL data from the other paths. If two or three paths are below the threshold, the wireless device 120 begin to duplicate the data across all three paths.

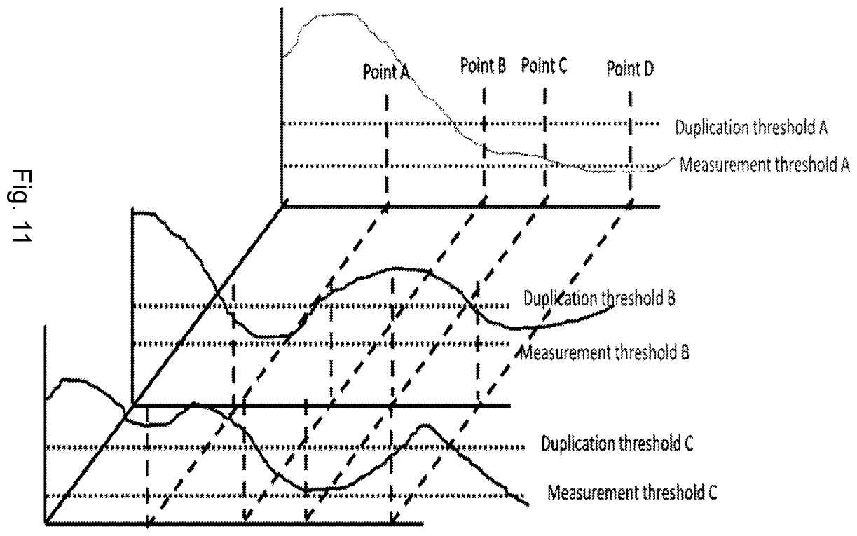

FIG. 11 depicts duplication thresholds in time for all the paths A, B and C. In FIG. 11 an example how the duplication threshold works is shown. At point A, path A, B and C are all above their respective duplication thresholds. At point B, path A is below its threshold, but path B and C are above. The wireless device 120 will select whether to transmit via path B or C and any data transmitted via these paths are duplicated via path A.

At point C, path A and C are below their respective thresholds, but path B is above it's threshold, the wireless device 120 will transmit one replica of the data packets via path B and further replicas of the data packets via both path A and path C. This means that replicas of the data packets are transmitted on path A, path B and path C.

At point D, path A is below the measurement threshold, while paths B, and C are below the duplication threshold. The network will release path A and the wireless device 120 will duplicate the data across path B and C.

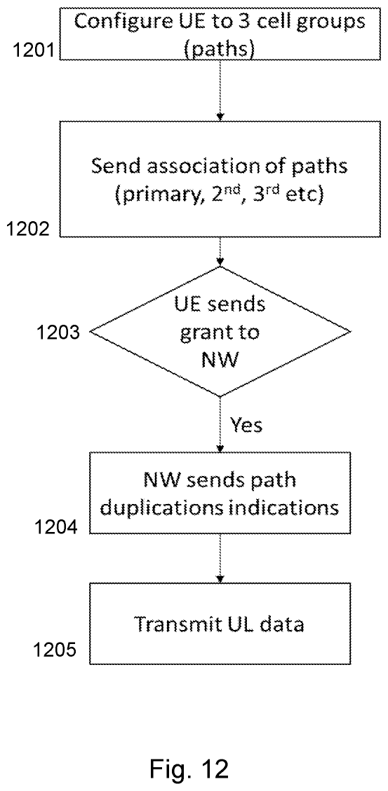

A flow chart in FIG. 12 shows example embodiments of a general procedure performed by radio node 110, 120 such as e.g., the wireless device 120. In this example, the wireless device 120, referred to as UE in FIG. 12, is configured 1201 with three cell groups with respective paths, the primary path A, the secondary path B and the tertiary path C. This relates to and may be combined with the Action 801 as described above. The wireless device 120 receives 1202 an association on these paths, i.e., primary, secondary, etc., e.g., sent by the network such as the network node 110. Also, this relates to and may be combined with the Action 801 as described above. When the wireless device 120 wants to transmit the data packets it sends a scheduling requests (SR) to the Network (NW) such as the network node 110 and receives 1203 a grant message from the NW such as the network node 110. When the NW such as the master node, e.g., the network node 110, allocates the grant it also sends characteristics of the paths associated to the split radio bearer such as a duplication indication. This is obtained 1204 by the wireless device 120 as characteristics of the paths associated to the split radio bearer mentioned above. This relates to and may be combined with the Action 802 as described above Note that the NW may also send the duplication indications as part of the cell group configuration. The wireless device 120 then establishes whether or not to transmit replicas of the data packets, and which one or more paths out of the three or more paths associated to the split radio bearer that shall be used based on the characteristics of the paths associated to the split radio bearer such as a duplication indication, and then transmits 1205 the data packets accordingly. This relates to and may be combined with the Action 803 as described above.

Some embodiments may provide a more dynamic procedure is. In these embodiments the NW, such as the master node, e.g. the network node 110, monitors the signal quality of the different paths and thereafter may update the duplication indications to the wireless device 120 to be obtained by the wireless device 120 as characteristics of the paths associated to the split radio bearer mentioned above. The signal quality may for example be:
RSRP measurements that the wireless device 120 sends regularly to the NW,
CSI (SINR) measurements or
throughput over each path
HARQ retransmission etc.

Below follows some example embodiments of the method as described above. These example embodiments may be combined with any suitable embodiments above.

In this example a method performed by the wireless device 120 for determining how to duplicate uplink (UL) data packets when connected via three or more paths to one or more cell groups, e.g. to at least the MCG, the SCG and the at least one third cell group, e.g. a TCG. The wireless device 120 is configured with a radio bearer split at least between the MCG, SCG, and TCG.

The wireless device 120 obtains 802 characteristics of the respective path out of the three or more paths, by receiving a message comprising the characteristics of paths from the network node 110 in the wireless communications network 100. The characteristics of paths e.g. comprises one or more of the following:
One or more indications of which path associated to the MCG; SCG, and TCG are identified as the primary, secondary and tertiary path, and
One or more indications of which paths the wireless device 120 shall use for replication of the data packets.

When receiving an UL grant from the network node 110, the wireless device 120 establishes 803, such as determines, based on the obtained characteristics of paths such as the received replication indications, which of the available paths the wireless device should transmit data on and which path to replicate data on.

The wireless device 120 transmits the UL data via one or more of the available paths out of the at least three paths as established.

The message may indicate whether the wireless device 120 shall duplicate the UL data via zero, one, two, or more paths.

In some embodiments, the message indicates that the wireless device 120 shall transmit the data packets via one path and/or duplicate the data packets via another path. The message may indicate that the wireless device 120 shall establish, such as determine or select, which paths to transmit the data packets via any one or more out of: One path or two other paths (e.g. A or (B+C)); or Two paths or two other paths (e.g. (A+B) or (A+C)). The wireless device 120 will then transmit the data packets via the selected paths. The one or more paths may correspond to any permutation of the MCG, SCG and TCG path.

The message may further include one or more indications of one or more UL data packet thresholds. Upon receiving the UL data to transmit, the wireless device 120 may determine whether a path is permissible to select depending on if the amount of data packets exceeds the one or more thresholds.

The replication on paths may only be performed if the associated path is permissible, e.g., replicate on path C and path B only if path B is permissible and the wireless device 120 selects path B, otherwise always use path A. This means that if there is only a small amount of data in the UL data buffer, which is below the one or more thresholds, the wireless device 120 only utilizes one of the paths, e.g., path A as the additional bandwidth provided by the other paths, e.g., paths B and C, are not needed for small amounts of data. If the amount of data in the UL data buffer exceeds the one or more thresholds, the wireless device 120 will utilize these paths, which provides additional capacity. The message may indicate that the wireless device 120 shall transmit the UL data via one path and if established to replicate the data packets, replicate the data packets via two other paths, or transmitting replicated data packets via all three paths.

In some embodiments, the message indicates that the wireless device 120 shall transmit the data packets via one path and replicate the data packets via zero other paths, i.e., transmitting the data packets via only one path.

Below follows some other example embodiments of the method as described above. These other example embodiments may be combined with any suitable embodiments above.

The wireless device 120 obtains 802 characteristics of paths associated to the split radio bearer, by receiving a message comprising the characteristics of paths from the network node 110 in the wireless communications network 100. The characteristics of paths e.g., comprises one or more of the following:
One or more indications of which path associated to the MCG; SCG, and TCG are identified as the primary, secondary and tertiary path, and
one or more indications signal quality associated to one or more paths.

The wireless device 120 may perform measurements on the signals toward the MCG; the SCG, and the TCG, and establishing 803, by determining, whether the signal quality is above a signal threshold associate to each of the paths.

Upon determining that the signal quality of one of the paths is below the associated threshold, the wireless device 120 may replicate the data packets and transmit replicas of the data packets on one or more of the other paths to that path.

The wireless device 120 may establish 803, such as determine, that the signal quality is below the associated threshold on two or more paths. The wireless device 120 may then replicate and transmit the same data packets to all three paths.

The signal threshold may e.g. indicate one or more of RSRP, RSRQ and SINR.

To perform the method actions above, the radio node 110, 120 is configured to handling paths for transmissions related to data packets in the wireless communications network 100. The radio node 110, 120 may be any one out of the wireless device 120 and the network node 110. The wireless device 120 is connectable via three or more paths to one or more cell groups. The wireless device 120 is adapted to be configured with a split radio bearer comprising the three or more paths between the wireless device (120) and the one or more cell groups.

In some embodiments, the one or more cell groups comprises an MCG, an SCG, and one or more third cell groups. In some embodiments, the third cell group may be adapted to comprise any one out of an SCG2, and a TCG. In some embodiments, the wireless device 120 being connectable to the third cell group comprises that the wireless device 120 is connectable to multiple third cell groups, and wherein the multiple third cell groups are identified as multiple tertiary paths.

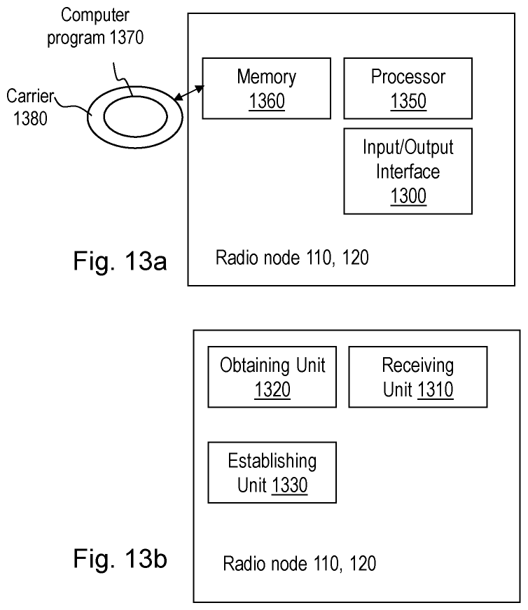

The radio node 110, 120 may comprise an arrangement depicted in FIGS. 13a and 13b. The radio node 110, 120 may comprise an input and output interface 1300 configured to communicate with other entities in the wireless communications network 100, such as the wireless device 120, the network node 110, the second network node 112, the third network node 113, the MCG, the SCG, and/or the third cell group. The input and output interface 1300 may comprise a wireless receiver (not shown) and a wireless transmitter (not shown).

In some embodiments, wherein the radio node 110, 120 is a wireless device 120, the radio node 110, 120 may further be configured to, e.g., by means of a receiving unit 1310 in the radio node 110, 120, receive a configuration from the network node 110, which configuration is adapted to configure the wireless device 120 to perform said establishing.

The configuration may further comprise any one or more out of:
Which of the paths to any of the respective one or more cell groups such as e.g., to any of the respective MCG, SCG, and the third cell group, that are associated to the split radio bearer, wherein the paths are adapted to comprise at least a first path 131, a second path 132 and a third path 133, and
which of the respective paths 131, 132, 133 that are identified as a primary path A, a secondary path B, and a tertiary path C.

The configuration may further be adapted to comprise the obtaining of said characteristics of paths.

The radio node 110, 120 may further be configured to, e.g. by means of an obtaining unit 1320 in the radio node 110, 120, obtain characteristics of the respective path out of the three or more paths,

The radio node 110, 120 may further be configured to, e.g., by means of the obtaining unit 1320 in the radio node 110, 120, obtain the characteristics of paths related to the split radio bearer by measuring the signal quality of the paths, adapted to comprise at least a first path 131, a second path 132 and a third path 133, to the respective MCG; SCG, and the third cell group.

The radio node 110, 120 may further be configured to, e.g., by means of an establishing unit 1330 in the radio node 110, 120, based on the obtained characteristics of the respective path, establish whether or not to transmit replicas of the data packets, and which one or more paths out of the three or more paths associated to the split radio bearer that shall be used for any one out of: Transmitting the data packets on, or transmitting replicas of the data packets on.

The radio node 110, 120 may further be configured to, e.g. by means of the establishing unit 1330 in the radio node 110, 120, establish, based on the obtained characteristics of the respective path, by determining whether or not to transmit replicas of the data packets, and which one or more paths that shall be used for transmitting the data packets on, or transmitting replicas of the data packets on, based on whether the measured signal quality of the respective path is fulfilling a criterion associated to each of the respective path.

The radio node 110, 120 may further be configured to, e.g. by means of the establishing unit 1330 in the radio node 110, 120, establish whether or not to transmit replicas of the data packets, and which one or more paths that shall be used for transmitting the data packets on, or transmitting replicas of the data packets on, based on the obtained characteristics of the respective path, further based on an amount of data in a data buffer of the of the radio node 110, 120.

In some embodiments, the paths are adapted to comprise at least a first path 131, a second path 132 and a third path 133, and wherein the radio node 11, 120 further is configured to perform said establishing e.g., by means of the establishing unit 1330 in the radio node 110, 120, by determine whether:
a first path 131 shall be used for transmitting the data packets on, and neither of a second path 132 and a third path 133 shall be used for transmitting replicas of the data packets on, or
the second path 132 and the third path 133 shall be used for transmitting replicas of the data packets on, and the first path 133 shall not be used for transmitting the data packets on.

In some embodiments, the paths are adapted to comprise at least a first path 131, a second path 132 and a third path 133, and wherein the radio node 110, 120 further is configured to perform said establishing, e.g., by means of the establishing unit 1330 in the radio node 110, 120, by:
determine to send replicas of the data packets and that the first path 131 shall be used for transmitting one replica of data packets on and determine that any one out of:
the second path 132 shall be used for transmitting another replica of the data packets on, or
the third path 133 shall be used for transmitting another replica of the data packets on.

The embodiments herein may be implemented through a respective processor or one or more processors, such as the processor 1350 of a processing circuitry in the radio node 110, 120 depicted in FIG. 13a, together with respective computer program code for performing the functions and actions of the embodiments herein. The program code mentioned above may also be provided as a computer program product, for instance in the form of a data carrier carrying computer program code for performing the embodiments herein when being loaded into the radio node 110, 120. One such carrier may be in the form of a CD ROM disc. It is however feasible with other data carriers such as a memory stick. The computer program code may furthermore be provided as pure program code on a server and downloaded to the radio node 110, 120.

The radio node 110, 120 may further comprise a memory 1360 comprising one or more memory units. The memory 1360 comprises instructions executable by the processor in the radio node 110, 120. The memory 1360 is arranged to be used to store e.g. information, indications, symbols data, configurations, and applications to perform the methods herein when being executed in the radio node 110, 120.

In some embodiments, a computer program 1370 comprises instructions, which when executed by the respective at least one processor 1350, cause the at least one processor of the wireless device 120 to perform the actions above.

In some embodiments, a respective carrier 1380 comprises the respective computer program 1370, wherein the carrier 1380 is one of an electronic signal, an optical signal, an electromagnetic signal, a magnetic signal, an electric signal, a radio signal, a microwave signal, or a computer-readable storage medium.

Those skilled in the art will appreciate that the units in the radio node 110, 120 described above may refer to a combination of analog and digital circuits, and/or one or more processors configured with software and/or firmware, e.g., stored in the radio node 110, 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

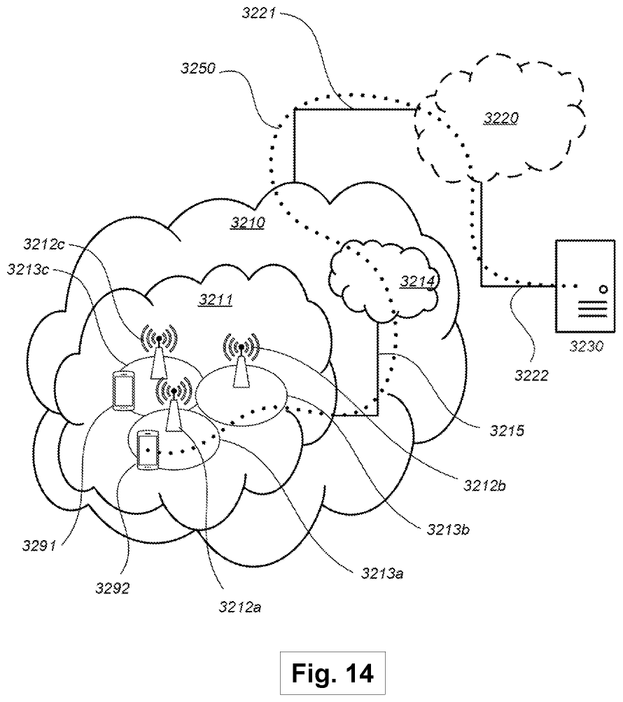

With reference to FIG. 14, in accordance with an embodiment, a communication system includes a telecommunication network 3210, such as a 3GPP-type cellular network, e.g., the wireless communications network 100, which comprises an access network 3211, such as a radio access network, and a core network 3214. The access network 3211 comprises a plurality of base stations 3212a, 3212b, 3212c, e.g., the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291, e.g., the wireless device 120, located in coverage area 3213c is configured to wirelessly connect to, or be paged by, the corresponding base station 3212c. A second UE 3292 e.g., the UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

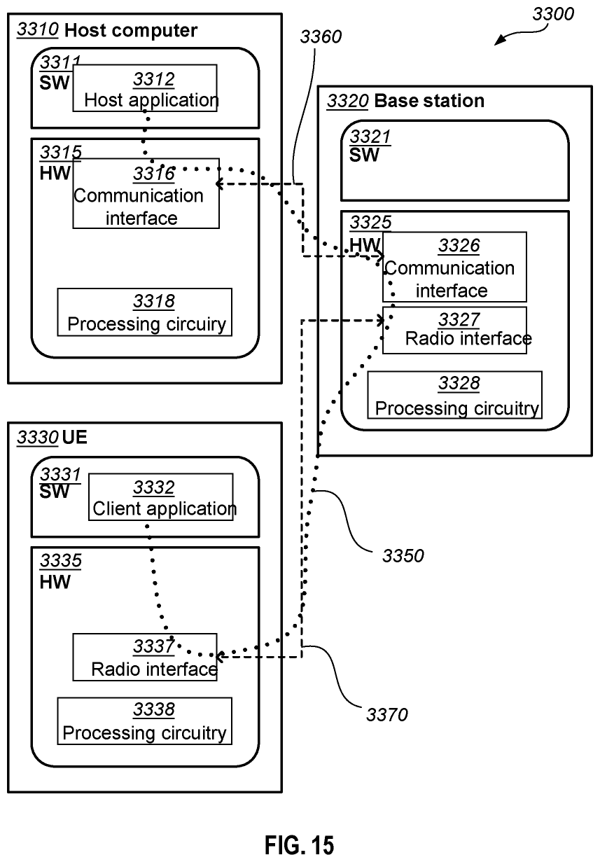

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

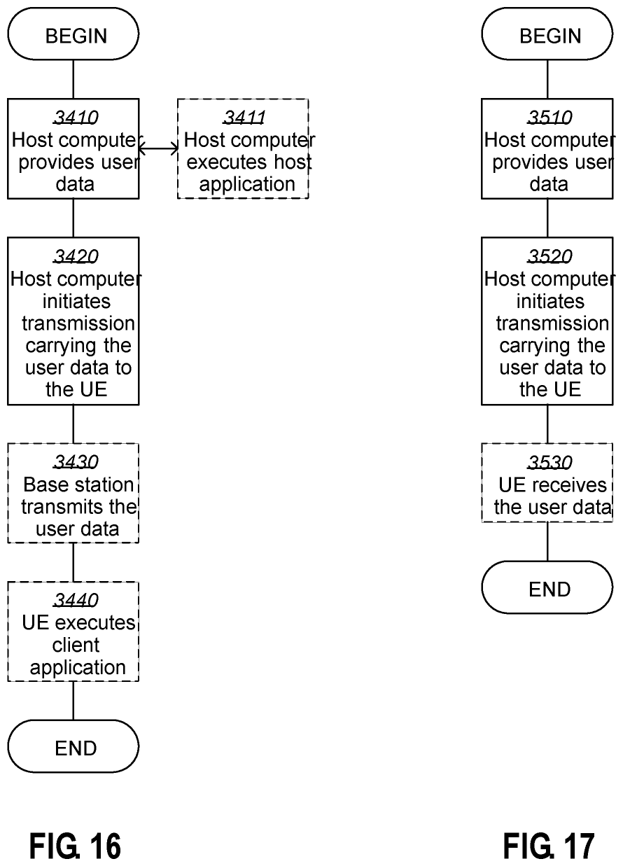

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 15 and FIG. 14. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 15 and FIG. 14. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

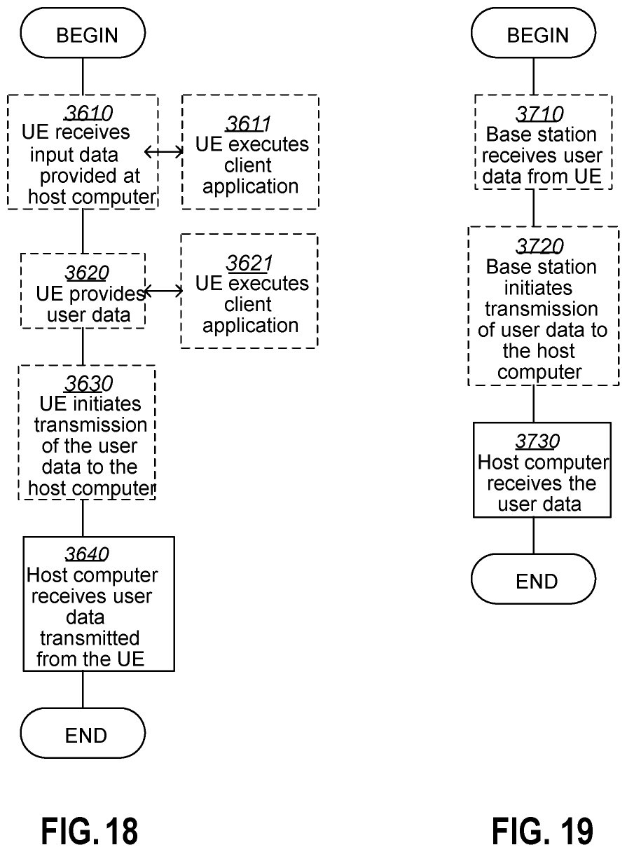

FIG. 18 is a flowchart illustrating a method implemented in a communication system, in accordance with one embodiment. The communication system includes a host computer, a base station such as an AP STA, and a UE such as a Non-AP STA which may be those described with reference to FIG. 15 and FIG. 14. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station such as a AP STA, and a UE such as a Non-AP STA which may be those described with reference to FIG. 15 and FIG. 14. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e., meaning “consist at least of”.

The embodiments herein are not limited to the preferred embodiments described above. Various alternatives, modifications and equivalents may be used.

1. A method performed by a radio node for handling paths for transmissions related to data packets in a wireless communications network, wherein the radio node is represented by any one out of: a wireless device and a network node, wherein the wireless device is connected via three or more paths to one or more cell groups, and wherein the wireless device is configured with a split radio bearer comprising the three or more paths between the wireless device and the one or more cell groups, the method comprising:
obtaining characteristics of the respective path out of the three or more paths, and
based on the obtained characteristics of the respective path, establishing whether to transmit replicas of the data packets, and which one or more paths out of the three or more paths associated to the split radio bearer that shall be used for any one out of:
transmitting the data packets on, or
transmitting replicas of the data packets on.

2. The method according to claim 1, wherein the radio node is a wireless device, the method further comprising:
receiving a configuration from a network node, that configures the wireless device to perform said establishing.

3. The method according to claim 1, wherein the configuration further comprises any one or more out of:
which of the paths to any of the respective one or more cell groups that are associated to the split radio bearer, wherein the paths comprise at least a first path, a second path, and a third path, and
which of the respective paths that are identified as a primary path, a secondary path, and a tertiary path.

4. The method according to claim 1,
wherein:
the obtaining of the characteristics of paths related to the split radio bearer comprises measuring the signal quality of the paths comprising at least a first path, a second path, and a third path, to the respective one or more cell groups, and wherein said establishing based on the obtained characteristics of the respective path, comprises: determining whether to transmit replicas of the data packets, and which one or more paths that shall be used for transmitting the data packets on, or transmitting replicas of the data packets on, based on whether the measured signal quality of the respective path is fulfilling a criterion associated to each of the respective path.

5. The method according to claim 1, wherein the configuration further comprises the obtaining of said characteristics of paths.

6. The method according to claim 1, wherein the establishing of whether to transmit replicas of the data packets, and which one or more paths that shall be used for transmitting the data packets on, or transmitting replicas of the data packets on, based on the obtained characteristics of the respective path, is further based on an amount of data in a data buffer of the radio node.

7. The method according to claim 1, wherein the paths comprise at least a first path, a second path, and a third path, and wherein said establishing comprises: determining whether:
a first path shall be used for transmitting the data packets on, and neither of a second path and a third path shall be used for transmitting replicas of the data packets on, or
the second path and the third path shall be used for transmitting replicas of the data packets on, and the first path shall not be used for transmitting the data packets on.

8. The method according to claim 1, wherein the paths comprise at least a first path, a second path, and a third path, and wherein said establishing, comprises:
determining to send replicas of the data packets and that the first path shall be used for transmitting one replica of data packets on and determining that any one out of:
the second path shall be used for transmitting another replica of the data packets on, or
the third path shall be used for transmitting another replica of the data packets on.

9. The method according to claim 1, wherein any one or more out of:
the one or more cell groups comprises a Master Cell Group (MCG), a Secondary Cell Group (SCG) and one or more third cell group, and the third cell group comprises any one out of: an SCG2 or a Tertiary Cell Group (TCG).

10. A computer program comprising instructions, which when executed by a processor, causes the processor to:
obtain characteristics of the respective path out of the three or more paths, and
based on the obtained characteristics of the respective path, establish whether to transmit replicas of the data packets, and which one or more paths out of the three or more paths associated to the split radio bearer that shall be used for any one out of:
transmit the data packets on, or
transmit replicas of the data packets.

11. (canceled)

12. A radio node configured to handle paths for transmissions related to Uplink (UL) data packets in a wireless communications network, wherein the radio node is adapted to be any one out of: a wireless device and a network node, wherein the wireless device is connectable to via three or more paths to one or more cell groups, and wherein the wireless device is adapted to be configured with a split radio bearer comprising the three or more paths between the wireless device and the one or more cell groups, the radio node further configured to:
obtain characteristics of the respective path out of the three or more paths, and
based on the obtained characteristics of the respective path, establish whether to transmit replicas of the data packets, and which one or more paths out of the three or more paths associated to the split radio bearer that shall be used for any one out of:
transmitting the data packets on, or
transmitting replicas of the data packets on.

13. The radio node according to claim 12, further configured to:
receive a configuration from a network node, the configuration is adapted to configure the wireless device to perform said establishing.

14. The radio node according to claim 12, wherein the configuration further comprises any one or more out of:
which of the paths to any of the respective one or more cell groups, that are associated to the split radio bearer, wherein the paths are adapted to comprise at least a first path, a second path, and a third path, and
which of the respective paths that are identified as a primary path, a secondary path, and a tertiary path.

15. The radio node according to claim 13, further being configured to:
obtain the characteristics of paths related to the split radio bearer by measuring the signal quality of the paths, adapted to comprise at least a first path, a second path, and a third path, to the respective MCG, SCG, and the third cell group, and
establish, based on the obtained characteristics of the respective path, by determining whether to transmit replicas of the data packets, and which one or more paths that shall be used for transmitting the data packets on, or transmitting replicas of the data packets on, based on whether the measured signal quality of the respective path is fulfilling a criterion associated to each of the respective path.

16. The radio node according to claim 12, which the configuration further is adapted to comprise the obtaining of said characteristics of paths.

17. The radio node according to claim 12, further configured to establish whether to transmit replicas of the data packets, and which one or more paths that shall be used for transmitting the data packets on, or transmitting replicas of the data packets on, based on the obtained characteristics of the respective path, further based on an amount of data in a data buffer of the radio node.

18. The radio node according to claim 12, wherein the paths are adapted to comprise at least a first path, a second path, and a third path, and wherein the radio node further is configured to perform said establishing by determining whether:
a first path shall be used for transmitting the data packets on, and neither of a second path and a third path shall be used for transmitting replicas of the data packets on, or
the second path and the third path shall be used for transmitting replicas of the data packets on, and the first path shall not be used for transmitting the data packets on.

19. The radio node according to claim 12, wherein the paths are adapted to comprise at least a first path, a second path, and a third path, and wherein the wireless device further is configured to perform said establishing by:
determining to send replicas of the data packets and that the first path shall be used for transmitting one replica of data packets on and determining that any one out of:
the second path shall be used for transmitting another replica of the data packets on, or
the third path shall be used for transmitting another replica of the data packets on.

20. The radio node according to claim 12, wherein any one or more out of:
the one or more cell groups are adapted to comprise a Master Cell Group (MCG) a Secondary Cell Group (SCG), and one or more third cell group, and wherein the third cell group is adapted to comprise any one out of: an SCG2 or a Tertiary Cell Group (TCG).
